(19) United States
(12) Patent Application Publication
(10) Pub. No.: US 2007/0071858 A1
(43) Pub. Date: Mar. 29, 2007

(54) CRYOGENIC PEELING PROCESS

(76) Inventors: Jorge Succar, Yorba Linda, CA (US); Lorenzo Brescia, Omaha, NE (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 11/466,366

(22) Filed: Aug. 22, 2006

Related U.S. Application Data
(60) Provisional application No. 60/710,121, filed on Aug. 22, 2005.

(51) Int. Cl. A23L 1/216

(52) U.S. Cl. 426/481

(57) ABSTRACT

The present invention relates to a method for peeling a fruit or vegetable, in particular the method is directed to a cryogenic peeling process, where the fruit or vegetable surface is cryogenically frozen and the skin is thawed before the peel/skin is removed.

### FIELD OF INVENTION

The present invention relates to a method for removing the peel from produce, and more specifically, a method for peeling tomatoes. In particular, the present method cryogenically freezes the surface of the tomato, before the peel of the tomato is extracted.

### BACKGROUND OF INVENTION

Removing the outer skin of produce, i.e. fruits and vegetables, is a common procedure known as peeling that is typically required before the produce is further processed. Removing the peel/skin aides in processing the produce as well as the appearance, quality, texture, and flavor of the processed produce. An efficient peeling process retains as much of the flesh of the produce as possible, causes minimal damage to the produce, and does not change the quality or flavor of the produce.

Over the years numerous different methods have been used to peel produce, and more particularly tomatoes. Individuals have developed methods for non-commercial use that include hand peeling, chemical agents sprayed on the peel, mechanical processes, heat peeling, cold peeling, and combinations thereof. These methods focus on separating the peel from the flesh with minimal damage caused to the flesh of the produce. Non-commercial methods typically cause less damage to the produce flesh, but disadvantageously are labor intensive and require an individual to hand peel the produce during the process.

In order to peel large quantities of produce industrial/commercial methods were developed. Industrial peeling methods found in the industry include either chemically or mechanically removing the skin from the flesh of the produce. These peeling processes do not require an individual to manually remove the peel, but instead rely on continuous methods or production systems operated on an industrial scale to remove the peel of the produce. Current industrial methods used in the industry include lye peeling and steam peeling.

Lye peeling involves submersing or spraying the tomato with a hot caustic solution, effluent, such as a solution of sodium hydroxide (NaOH) or potassium hydroxide (KOH). The caustic solution softens the tomato peel allowing removal in a single thin layer with the flesh remaining mostly intact. The disadvantage to this method is the requirement of a caustic material, resulting in operator hazards and the need to treat the effluent before discharge into the environment.

Steam peeling is another method used in an industrial setting for the removal of the tomato peels. In this method, the tomatoes are exposed to steam, whereby loosening the skin, which is then removed by mechanical means. This method is more environmentally friendly than lye peeling, but does not yield as much flesh after the peeling. The steam peeling method is disadvantageous because it results in an inferior product because some of the peel remains adhered to the flesh and parts of the flesh are cooked due to the steam, resulting in a mushy product.

As such, it is desired to have a method for peeling produce that achieves optimum peel removal with minimum yield loss of the produce flesh and produces a final peeled product that is firmer and ready for further processing. The method desired is implemented in a continuous or batch process for industrial or commercial processing for peeling produce. Further, it is desired that the by-products of the peeling process will not require additional disposal requirements.

### SUMMARY OF INVENTION

The present invention relates to a method for removing the skin from produce, such as fruits and vegetables, in particular tomatoes. The method is unique, because it provides an improved industrial method for removing the skin/peel from a tomato and produces a peeled tomato product with firmer flesh that is ready for subsequent processing.

The method is initiated by obtaining an amount of produce. The produce can be fruit, vegetables, or combinations thereof, hereafter the produce will be referred to as a “vegetable”. The type and amount of vegetable is dependent on the end product desired or the subsequent processing methods employed. The vegetable is initially cleaned and sorted to remove non-desired vegetables.

After the vegetable is cleaned and sorted it is exposed to a freezing medium. The freezing medium can be any compound known in the industry, such as liquid nitrogen, Freon 12, chilled brine, liquid oxygen, argon, or combinations thereof. Any freezing medium can be used as long is it rapidly freezes the surface of the vegetable.

Subsequent to freezing the vegetable's surface, the vegetable is held at ambient conditions for a period of time. The vegetable is then placed in a hot water bath to precipitate the thawing of the skin of the vegetable. During the thawing period only the vegetable surface is allowed to thaw, while the flesh of the vegetable remains frozen. Any method can be used to quickly heat the surface of the vegetable, whereby thawing the surface peel and the flesh bound to the peel, as long as a portion of the vegetable flesh remains frozen.

After the skin has been allowed to thaw the vegetable is processed by any peeling apparatus known in the industry. Preferably, the peeling apparatus is a mechanical peeling apparatus that functions to remove the skin from the flesh of the vegetable and separate the components for further processing dependent on the desired end food product.

### DETAILED DESCRIPTION

The present invention is directed to a method for peeling produce, such as fruits or vegetables. In particular, the method relates to an industrial or commercial method for processing large quantities of vegetables, such as tomatoes, whereby the peels are removed from the flesh of the tomato. As a result a whole peeled tomato is produced that is firm with little flesh damage and is ready for further processing.

The present method is initiated by obtaining an amount of produce, such as a single fruit or vegetable or a large quantity of fruits or vegetables. The produce can be any fruits or vegetables, including but not limited to tomatoes, potatoes, cucumber, apples, pears, and combinations thereof, (hereafter referred to as “vegetables”). Any amount of vegetables can be treated; however, the method is designed for typical large commercial or industrial amounts. In one embodiment, the amount of processed vegetables is from 1 ton/hr to more than 500 ton/hr. In another embodiment, the vegetables are prepared as part of an industrial batch process or a continuous process.

Once the vegetable or vegetables are obtained, they are introduced into a flume system for cleaning and sorting before further processing. The cleaning and initial preparation is common in the industry and is used as a first step to remove damaged vegetables, as well as foreign particles from the vegetables, which are not desired and decrease the quality of the finished food product. In one embodiment, the cleaning step includes using an amount of water or any other cleaning agent used in the industry. Any process or agent currently used in the industry that removes impurities and prepares the vegetables for subsequent processing can be used to clean and prepare the vegetable.

In another embodiment, after the vegetable is cleaned or during the cleaning process it is exposed to an amount of an organic, inorganic, or enzymatic compound or process to precondition the vegetable and help facilitate the subsequent freezing and peeling process. Any method or agent can be employed that is currently used in the industry that helps facilitate the freezing process and subsequent removal of the vegetable peel. Exposure to the preconditioning compound or process improves the efficiency of the peeling process and subsequent yield of the vegetable flesh.

In an optional embodiment, the vegetable is dried after the cleaning and preparation steps. Any method known in the industry can be used to dry the surface of the vegetable. Drying the surface of the vegetable will aide in the freezing process by increasing efficiency and minimizing the exposure time required.

The vegetables are now ready for exposure to a freezing/chilling medium. In another embodiment, the vegetables are placed in or passed through a pre-chill chamber or exposed to a pre-chill medium, where the vegetable is cooled in preparation of introduction to the freezing medium. Any method known in the industry for cooling a vegetable can be used for pre-chilling the vegetable. In one embodiment, a pre-chill chamber is used that includes gas that is released from the freezing medium, such as liquid nitrogen gas or Freon 12 gas. The gas is recovered from the freezing chamber and is diverted to the pre-chill chamber where the cooling process is initiated. By pre-chilling the vegetable, through the use of recovered gas from the freezing medium, the efficiency of the chilling process is increased, and less freezing medium is used to freeze the vegetable.

The vegetables are next exposed to a freezing medium. The freezing medium is any medium known in the industry that can quickly freeze the surface of the vegetable, such as liquid nitrogen, Freon 12, chilled brine, liquid oxygen, argon, and combinations thereof. The freezing medium is administered to the vegetable through any means that causes exposure to the vegetable skin, such as immersion, spraying, impingement, or any other exposure method know in the industry. In one embodiment, the vegetables are immersed in the freezing medium for about one (1) to about sixty (60) seconds. The freezing medium functions to partially freeze the vegetable by freezing the vegetables surface, which includes the skin of the vegetable and a portion of the flesh of the vegetable near the vegetable surface.

In another embodiment, the exposure of the freezing medium to the skin of the vegetable occurs in a pressure controlled environment. Controlling the pressure allows subsequent processing to be conducted below standard atmospheric pressure. Lowering the pressure increases the efficiency of the freezing process, by lowering the freezing temperature and more rapidly freezing the surface of the vegetable. Any method known in the art for controlling the atmospheric pressure of a chamber used in processing vegetables can be used in the present invention.

In another embodiment, a step is included to ensure uniform exposure of the skin/peel of the vegetable to the freezing medium. The freezing chamber can include an agitation system that creates turbulence in the liquid or gas freezing medium. By agitating the freezing medium, uniform exposure of the vegetable occurs, translating into a rapid surface freeze for the vegetable and limiting over exposure of any one area on the vegetable. In one embodiment, the freezing chamber includes a pump to create turbulence in the freezing medium. Recirculation of the freezing medium, such as liquid nitrogen, creates turbulence and uniform exposure to the vegetable.

The surface frozen vegetables are then removed from the freezing chamber. In one embodiment, the vegetables are held for a period of time at ambient conditions. The amount of time the vegetables are held is from one (1) second to about ninety (90) seconds. During this period the surface of the vegetable, including the peel begin to thaw.

The vegetables are next exposed to a heating medium. The heating medium is any medium known in the industry that can quickly heat the surface of the vegetable, such as but not limited to hot air, steam, heating elements, hot liquid, and combinations thereof. In one embodiment, the heating medium is a hot water bath. The partially frozen vegetable is exposed to the hot water bath for a period of time to thaw the skin of the vegetable. In one embodiment, the time period is from about one (1) second to about ninety (90) seconds and the temperature is between about 60° F. to about 212° F. During this period, the skin of the vegetable and its bond to the flesh of the vegetable begins to thaw. Thawing the vegetable skin allows for easier removal during the peeling process.

After the peel of the vegetable has been warmed and thawed in the hot water bath it is then processed through a peeling apparatus. The partial freezing and subsequent thawing acts to soften the peel/skin of the vegetable and weakens the bonding forces between the vegetable skin. The peeling apparatus functions to remove the peel/skin from the flesh of the vegetable. Any method known in the industry can be used to peel the vegetable, such as cord scrubbers, pinch rollers, brush scrubbers, hydrodynamic shearing, pressurized gas streams, manual peeling, and combinations thereof. Preferably, the peeling apparatus will be any mechanical peeling device currently used in the industry.

In one embodiment, the vegetable is processed through a skin slitting apparatus. The skin slitting apparatus functions to precut the skin, whereby increasing the peeling efficiency when the vegetable is processed through a peeling apparatus. Any skin slitting apparatus known in the art can be used to remove the peel/skin of the vegetable. The mechanical skin slitting apparatus includes a set of “slitting” knifes or blades that deliver a precise linear cut on the softened tomato skin. After the skin is cut, the vegetable is “squeezed” out of its skin, causing the removal of the skin from the flesh.

In another embodiment, a secondary peeling operation may be required to remove any remnant peel remains attached to the vegetable. The secondary peeling can be any method known in the industry or one of those previously described.

Upon removal of the skin, the respective parts of the vegetable, i.e. the skin and flesh, are further processed. Dependent on the desired end product the vegetable flesh can be processed into any form used in the industry, including but not limited to whole, diced, sliced, or crushed vegetables. The skin of the vegetable is further processed for use in the industry, such as feed, pet food production, or other value-added process.

### EXAMPLES

### Example 1

Cryogenically peeled tomatoes can be produced by obtaining an amount of fresh whole tomatoes. The tomatoes are then cleaned with running water and any damaged or broken tomatoes are removed. After cleaning, the tomatoes are loaded into dipping basket for immersion into the freezing medium, liquid nitrogen. About 25 pounds of tomatoes are loaded per dipping basket. After the tomatoes are loaded into the dipping basket, the basket is lowered into the liquid nitrogen, where the tomato is completely immersed. The immersion of the tomatoes continues for about 20 seconds. The tomatoes are then removed from the liquid nitrogen and immersed in hot water that is about 200° F. for thirty (30 seconds. After immersion in both the liquid nitrogen and hot water, the tomatoes are processed through a conventional peeling machine. The peeling machine is a skin slitting peeler that cuts into the skin and then squeezes the vegetable, whereby separating the skin from the flesh of the tomato. After the tomatoes are skinned, further optional processing is conducted dependent on the tomato end product desired.

Thus, there has been shown and described a method of cryogenically peeling a vegetable which fulfills all the objects and advantages sought therefor. It is apparent to those skilled in the art, however, that many changes, variations, modifications, and other uses and applications to the method for cryogenically peeling the vegetables are possible, and also such changes, variations, modifications, and other uses and applications which do not depart from the spirit and scope of the invention are deemed to be covered by the invention, which is limited only by the claims which follows.

What is claimed is:

1. A method for removing the skin from a produce product, wherein the method comprises:
(a) pre-chilling the produce product;
(b) contacting the surface of the produce product with a freezing medium to produce a partially frozen produce product;
(c) exposing the partially frozen produce product to a heating medium, to thaw the surface of the partially frozen produce product; and,
(d) peeling the partially frozen produce product, to produce a peeled produce product.

2. The method of claim 1, wherein the produce product is selected from the group consisting of fruits and vegetables.

3. The method of claim 1, wherein the freezing medium is selected from the group consisting of liquid nitrogen, Freon 12, chilled brine, liquid oxygen, argon, and combinations thereof and the produce product is contacted with the freezing medium for a period of between about 1 second to about 60 seconds.

4. The method of claim 1, wherein the partially frozen produce product is held for a period of time between about 1 second and about 90 seconds at ambient conditions subsequent to freezing.

5. The method of claim 1, wherein the heating medium is selected from the group consisting of air, steam, heating elements, and liquid and is at a temperature of between about 60° F. and about 212° F.

6. The method of claim 1, wherein the partially frozen produce product is exposed to the hot medium for a period of time between about 1 second and about 90 seconds.

7. The method of claim 1, wherein the method further includes contacting the produce with a preconditioning compound selected from the group consisting of inorganic, organic, and enzymatic, to produce a surface weakened produce product.

8. The method of claim 1, wherein the method used to peel the partially frozen produce product is selected from the group consisting of a skin slitting peeler, a cord scrubber, pinch rollers, a brush scrubber, a hydrodynamic shear system, a pressurized stream of gas, manual peeling, and combinations thereof.

9. The method of claim 1, wherein the method for producing the peeled produce product is selected from the group of a continuous process and a batch process.

10. A produce product produced according to the process of claim 1.

11. A method for removing the skin from a produce product, wherein the method comprises:
(a) contacting the surface of the produce with a preconditioning compound;
(b) pre-chilling the produce;
(c) contacting the surface of the produce with a freezing medium to produce a partially frozen produce product;
(d) holding the partially frozen produce product at ambient conditions;
(e) contacting the surface of the partially frozen produce product with a heating medium, to produce a surface thawed partially frozen produce product; and,
(f) peeling the surface thawed partially frozen produce product, to produce a peeled produce product.

12. The method of claim 11, wherein the produce product is selected from the group consisting of fruits and vegetables.

13. The method of claim 11, wherein the freezing medium is selected from the group consisting of liquid nitrogen, Freon 12, chilled brine, liquid oxygen, argon, and combinations thereof and the produce product is contacted with the freezing medium for a period of between about 1 second to about 60 seconds.

14. The method of claim 11, wherein the partially frozen produce product is held for a period of time between about 1 second and about 90 seconds at ambient conditions subsequent to freezing.

15. The method of claim 11, wherein the heating medium is selected from the group consisting of air, steam, heating elements, and liquid and is at a temperature of between about 60° F and about 212° F.

16. The method of claim 11, wherein the partially frozen produce product is exposed to the heating medium for a period of time between about 1 second and about 90 seconds.

17. The method of claim 11, wherein the preconditioning compound is selected from the group consisting of inorganic, organic, and enzymatic, to produce a surface weakened produce product.

18. The method of claim 11, wherein the method used to peel the partially frozen produce product is selected from the group consisting of a skin slitting peeler, a cord scrubber, pinch rollers, a brush scrubber, a hydrodynamic shear system, a pressurized stream of gas, manual peeling, and combinations thereof.

19. The method of claim 11, wherein the method for producing the peeled produce product is selected from the group of a continuous process and a batch process.

20. A method for removing the skin from a tomato, wherein the method comprises:
(a) contacting the surface of the tomato with a preconditioning compound;
(b) pre-chilling the tomato;
(c) contacting the surface of the tomato with a freezing medium selected from the group consisting of liquid nitrogen, Freon 12, chilled brine, liquid oxygen, argon, and combinations thereof, to produce a partially frozen tomato;
(d) holding the partially frozen tomato at ambient conditions;
(e) contacting the surface of the partially frozen tomato with hot water, at a temperature of between about 60° F. and about 212° F., to produce a surface thawed partially frozen tomato; and,
(f) peeling the surface thawed partially frozen tomato, to produce a peeled tomato.
